(19) United States
(12) Patent Application Publication
(10) Pub. No.: US 2019/0352094 A1
(43) Pub. Date: Nov. 21, 2019

(54) Management System, Management Method, and Management Program

(71) Applicant: Hitachi Transport System, Ltd., Chuo-ku, Tokyo (JP)

(72) Inventors: Ryota KAMOSHIDA, Tokyo (JP); Yoriko KAZAMA, Tokyo (JP); Masaharu KONDOU, Tokyo (JP); Emi TAKAHASHI, Tokyo (JP); Shinji ASHIZAWA, Tokyo (JP)

(21) Appl. No.: 16/331,282

(22) PCT Filed: Sep. 29, 2016
(86) PCT No.: PCT/JP2016/078926

§ 371 Date: Mar. 7, 2019

(51) Int. Cl. B65G 1/137; G06Q 10/08

(52) U.S. Cl. CPC B65G 1/1373; G06Q 10/087

(57) ABSTRACT

A management system includes: a management apparatus; and a sorting region where articles are sorted to a plurality of sorting destinations, and article data that causes each of articles to correspond to size information about the article, work data that causes one or more articles to be sorted that are sorted to the sorting destinations among the articles to correspond to an article count of the one article or each of the articles to be sorted, and size information about the sorting region are stored in a memory device of the management apparatus. A processor of the management apparatus acquires size information about the articles to be sorted from the article data, identifies size information about each of the sorting destinations on the basis of the acquired size information about the articles to be sorted and the article count of the one article or each of the articles to be sorted in the work data, determines the number or a size of compartments of the sorting region for sorting the articles to be sorted to the sorting region on the basis of the identified size information about each of the sorting destinations and the size information about the sorting region in a case in which each of the sorting destinations is a belonging sorting destination to a sorting team that is a set of one or more sorting destinations, and allocates a determination result to the sorting region.

### TECHNICAL FIELD

The present invention relates to a management system, a management method, and a management program for managing articles.

### BACKGROUND ART

In a warehouse or a factory, a worker performs sorting work for shipment or the like of articles. The sorting work is work performed by the worker for picking articles stored in a shelf in accordance with an order and sorting the picked articles in a sorting destination such as a sorting box disposed in another shelf.

As a technique related to the sorting work, Patent Document 1 discloses a technique for classifying sorting information into blocks so that workloads for accommodating articles in regions are made uniform among the blocks each formed with a plurality of regions. Furthermore, Patent Document 2 discloses a technique for changing the number and the width of compartments depending on the amount or the size of articles to be transported in a picking facility where articles transported by a transport mobile body that loads the articles into a plurality of vertical shelves are put into an article collection container carried by carrying means.

The sorting work is laborious and time-consuming work. In the sorting work, a sorting team lumping a plurality of sorting destinations together in advance is created and a plurality of sorting destinations belonging to the same sorting team are disposed in the same sorting shelf.

### PRIOR ART DOCUMENT

### Patent Documents

Patent Document 1: JP-2008-143603-A

Patent Document 2: JP-2016-88650-A

### SUMMARY OF THE INVENTION

### Problem to be Solved by the Invention

However, Patent Document 1 does not give considerations to the size and the number of sorting destinations disposed in the sorting shelves although a sorting team is created so that workloads are uniform among the sorting shelves. Furthermore, Patent Document 2 does not mention a sorting team creation method although the number and the width of the compartments of the transport mobile body are changed depending on the amount or the size of articles to be transported.

An object of the present invention is to achieve improvement in work efficiency of sorting work.

### Means for Solving the Problems

According to a management system, a management method, and a management program that are one aspect of the invention disclosed in the present application, a memory device stores article data that causes each of articles to correspond to size information about the article, work data that causes one or more articles to be sorted that are sorted to a plurality of sorting destinations among the articles to correspond to an article count of the one article or each of the articles to be sorted, and size information about the sorting region where the articles are sorted to the sorting destinations, and the processor executes: an acquisition process of acquiring size information about the articles to be sorted from the article data, an identification process of identifying size information about each of the sorting destinations on the basis of the size information about the articles to be sorted acquired by the acquisition process and the article count of the one article or each of the articles to be sorted in the work data, a determination process of determining the number or a size of compartments of the sorting region for sorting the articles to be sorted to the sorting region on the basis of the size information about each of the sorting destinations identified by the identification process and the size information about the sorting region in a case in which each of the sorting destinations is a belonging sorting destination to a sorting team that is a set of one or more sorting destinations, and an allocation process of allocating a determination result by the determination process to the sorting region.

### Effect of the Invention

According to a typical embodiment of the present invention, it is possible to achieve improvement in work efficiency of sorting work. Objects, configurations, and effects other than those described above will be readily apparent from the description of embodiments given below.

### BRIEF DESCRIPTION OF THE DRAWINGS

FIG. 1 is an explanatory diagram depicting an example of work in a warehouse.

FIG. 2 is an explanatory diagram depicting an example of a system configuration of a management system according to a first embodiment.

FIG. 3 is an explanatory diagram depicting an example of a memory content of an article DB.

FIG. 4 is an explanatory diagram depicting an article storage state in storage shelves corresponding to the article DB depicted in FIG. 3.

FIG. 5 is an explanatory diagram depicting an example of a memory content of a work DB depicted in FIG. 2.

FIG. 6 is a block diagram depicting an example of a hardware configuration of a management apparatus.

FIG. 7 is a block diagram depicting an example of a functional configuration of the management apparatus.

FIG. 8 is a flowchart depicting an example of management process procedures by the management apparatus according to the first embodiment.

FIG. 9 is a flowchart depicting an example of detailed process procedures of a sorting team creation process (Step S802) depicted in FIG. 8.

FIG. 10 is an explanatory diagram depicting examples of a sorting shelf according to a second embodiment.

FIGS. 11A and 11B illustrate a flowchart depicting an example of detailed process procedures of the sorting team creation process (Step S802) depicted in FIG. 8 according to the second embodiment.

FIG. 12 is an explanatory diagram depicting an example of a warehouse using a carrier vehicle according to a third embodiment.

FIG. 13 is an explanatory diagram depicting an example of a system configuration of a management system according to the third embodiment.

FIG. 14 is an explanatory diagram depicting an example of sorting work in a work station according to the third embodiment.

FIG. 15 is a flowchart depicting an example of management process procedures by a management apparatus according to the third embodiment.

### MODES FOR CARRYING OUT THE INVENTION

### Example of Work in Warehouse

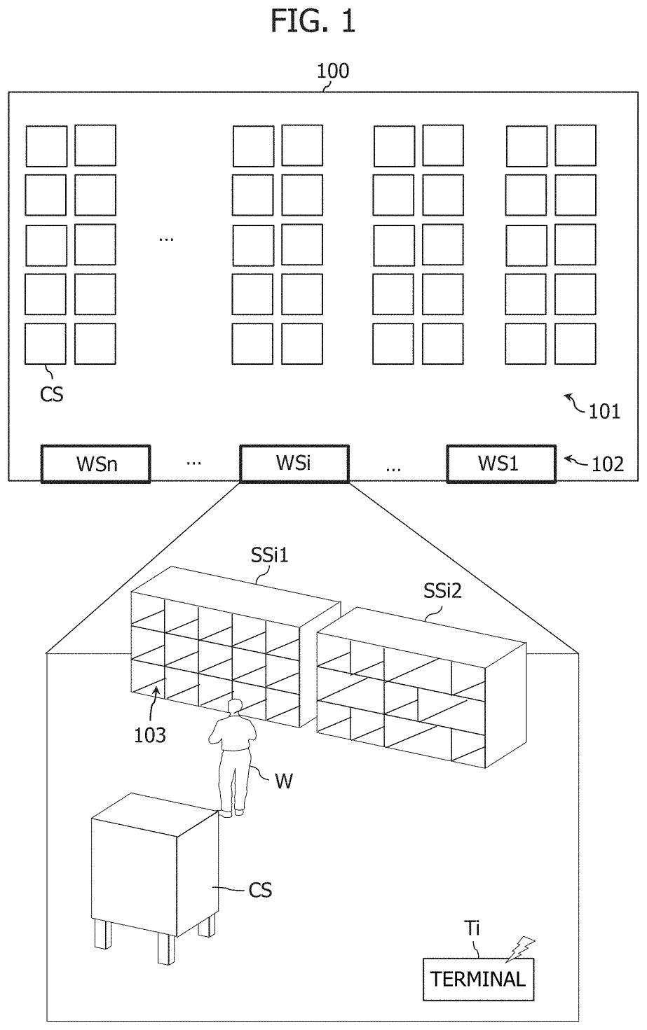

FIG. 1 is an explanatory diagram depicting an example of work in a warehouse. A warehouse 100 has a storage shelf area 101 and a work station area 102. One or more storage shelves CS are disposed in the storage shelf area 101. Each storage shelf CS is a storage region where commodity products are housed. One or more work stations WSi (where i is an integer satisfying 1≤i≤n) are provided in the work station area 102. A terminal Ti and one or more sorting shelves SSi (for example, two sorting shelves SSi1 and SSi2 in FIG. 1) are disposed in each work station WSi. Each sorting shelf SSi is a sorting region where articles to be sorted are sorted.

The storage shelves CS are carried into each work station WSi by a carrier mechanism such as a conveyor, a work robot, or a carrier vehicle or by manpower. A worker W performs sorting work in the work station WSi. Specifically, for example, the worker W picks articles housed in the storage shelves CS in accordance with order information displayed on the terminal and sorts the picked articles into compartments 103 of the sorting shelves. It is noted that the compartments 103 are spaces each for storing articles to a sorting destination in the sorting shelves and are spaces each for housing articles in the storage shelves. For example, the compartments 103 are spaces each demarcated by partition boards and shelf boards. Alternatively, the compartments 103 may be spaces each demarcated by slidable partition boards and shelf boards and having a variable size. In another alternative, the compartments 103 may be a plurality of sorting boxes mounted on the shelf boards. Furthermore, the sorting boxes may have the same size or different sizes. It is noted that one sorting box corresponds to, for example, one sorting destination.

Moreover, in a case of warehousing articles, the storage shelves CS where the articles are housed are carried into each work station WSi similarly to the sorting work. The worker W performs warehousing work in the work station WSi. Specifically, for example, the worker W picks the articles housed in the sorting shelves in accordance with order information displayed on the terminal Ti and stores the picked articles at a housing position of the articles (compartment 103) in the storage shelf CS.

### Example of System Configuration

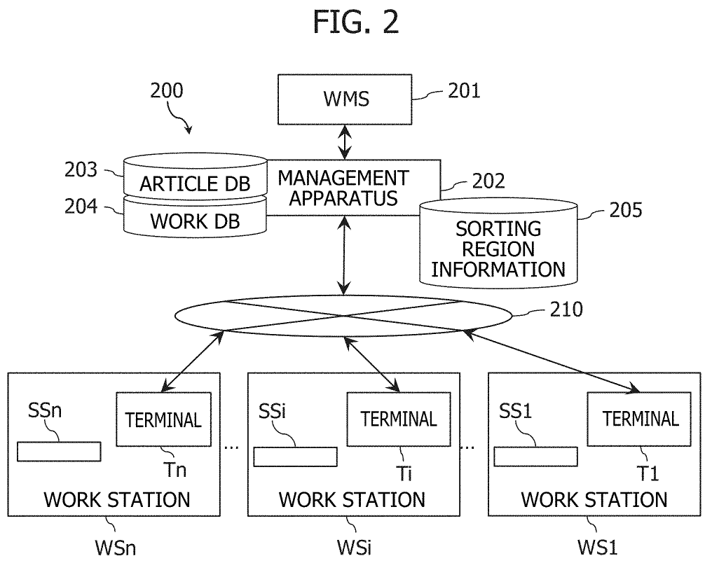

FIG. 2 is an explanatory diagram depicting an example of a system configuration of a management system according to a first embodiment. The management system 200 has a Warehouse Management System (WMS) 201, a management apparatus 202, and the work stations WSi. Each work station WSi has the terminal Ti and the sorting shelf SSi.

The WMS 201 is communicably connected to the management apparatus 202. The management apparatus 202 and the terminal Ti are communicably connected to each other via a network 210. The WMS 201 controls the management apparatus 202. Specifically, the WMS 201 transmits work data to the management apparatus 202. The work data is order information containing a sorting destination ID of a sorting destination to which articles to be sorted are sorted, article IDs of the articles to be sorted, and article counts of the articles to be sorted.

The management apparatus 202 controls the sorting work and the warehousing work. The management apparatus 202 manages an article DB 203, a work DB 204, and sorting region information 205. Information about an article (article information) is stored per article in the article DB 203. The work data described above is stored in the work DB 204. The sorting region information 205 is size information about a sorting region. Examples of the size information about the sorting region include a volumetric capacity at which the sorting region can accommodate articles. It is noted that the size information may be multiplied by a safety factor higher than 0 and equal to or lower than 1.

### Example of Memory Content of DBs

In the following description of databases or tables, a value in AA field bbb (where AA is a field name and bbb is a reference character) is often expressed as “AAbbb.” For example, a value of an article ID field 301 is expressed as article ID 301.

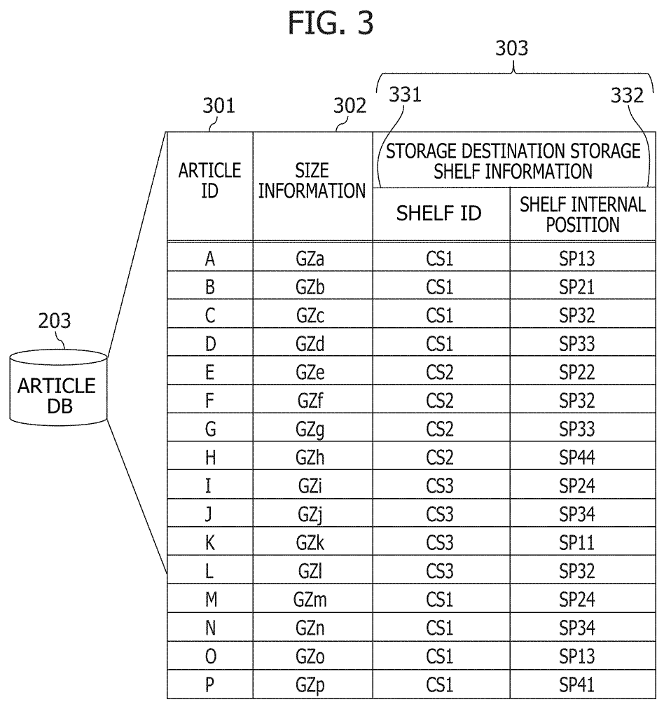

FIG. 3 is an explanatory diagram depicting an example of a memory content of the article DB 203. The article DB 203 has article ID fields 301, size information fields 302, and storage destination storage shelf information fields 303, and values of the fields 301 to 303 configure an entry that is article data about each article.

Each article ID field 301 is a memory region where an article ID is stored. The article ID 301 is identification information that uniquely identifies an article. Each size information field 302 is a memory area where size information about the article identified by the article ID 301 is stored. Specifically, the size information 302 is, for example, a volume of the article. More specifically, the size information 302 is, for example, a volume of a cube circumscribing the article.

Each storage destination storage shelf information field 303 has a shelf ID field 331 and a shelf internal position field 332. The shelf ID field 331 is a memory area where a shelf ID is stored. The shelf ID 331 is identification information that uniquely identifies each storage shelf CS. The shelf internal position field 332 is a memory area where a shelf internal position is stored. The shelf internal position 332 is position information that identifies an article housing position (a compartment 103) in the storage shelf CS. For example, an entry having the article ID 301 of “A” indicates that an article A with size information GZa is housed at a shelf internal position: SP13 of a shelf ID: CS1.

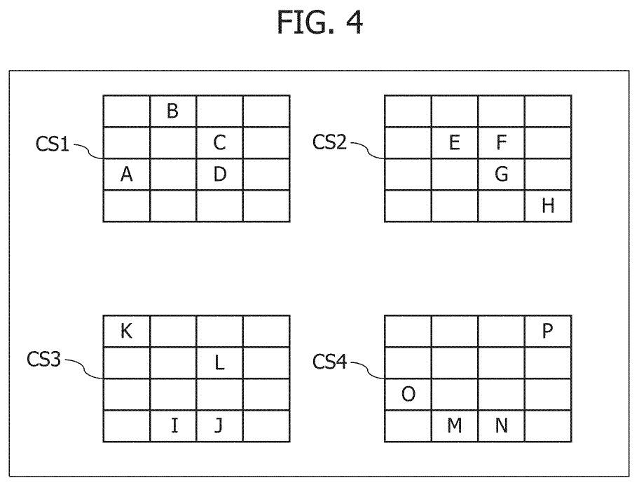

FIG. 4 is an explanatory diagram depicting an article storage state in the storage shelves CS corresponding to the article DB 203 depicted in FIG. 3. It is assumed herein that the storage shelves CS1 to CS4 each have compartments 103 in a matrix of 4×4 as a simple example. It is noted that x indicates a column number and y indicates a row number in a shelf internal position SPxy (where x and y are integers equal to or higher than 1 and equal to or lower than 4). For example, as depicted in FIG. 3, the article A is housed in the compartment 103 with a shelf internal position SP13 having the column number x=1 and the row number y=3 of the storage shelf CS1.

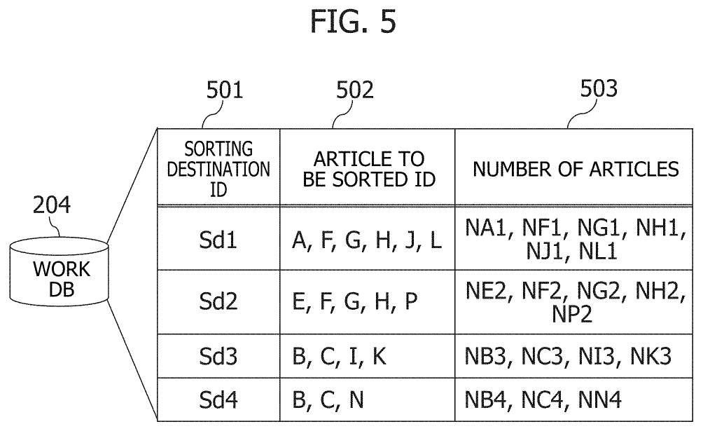

FIG. 5 is an explanatory diagram depicting an example of a memory content of the work DB 204 depicted in FIG. 2. The work DB 204 stores the work data as each entry. Specifically, for example, the work DB 204 has sorting destination fields 501, article to be sorted fields 502, and article count fields 503, and values of the fields 501 to 503 configure an entry that is the work data about each sorting destination.

Each sorting destination ID field 501 is a memory area where a sorting destination ID is stored. The sorting destination ID 501 is identification information that uniquely identifies a sorting destination. Each article to be sorted ID field is a memory area where articles to be sorted IDs are stored. The articles to be sorted IDs are the article IDs of articles that are to be sorted (article to be sorted) to the sorting destination. Each article count field is an area where article counts of the articles to be sorted are stored. For example, an entry (work data) having the sorting destination ID 501 of “Sd1” indicates that the article A with the article count of NA1, an article F with the article count of NF1, an article G with the article count of NG1, an article H with the article count of NH1, an article J with the article count of NJ1, and an article L with the article count of NL1 are sorted to the sorting destination Sd1. In the present embodiment, the management apparatus 202 generate such work data.

### Example of Hardware Configuration of Management Apparatus 202

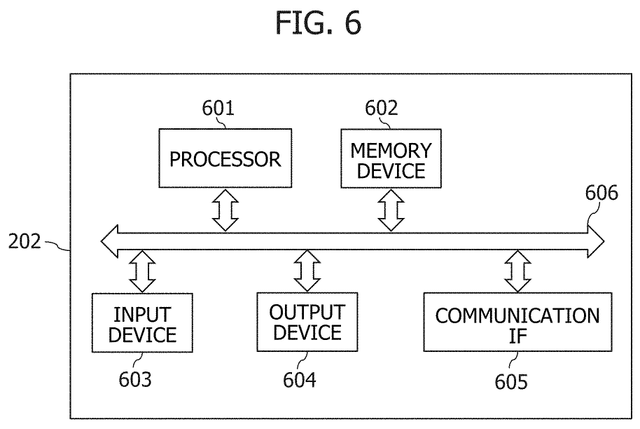

FIG. 6 is a block diagram depicting an example of a hardware configuration of the management apparatus 202. The management apparatus 202 has a processor 601, a memory device 602, an input device 603, an output device 604, and a communication interface (communication IF) 605. The processor 601, the memory device 602, the input device 603, the output device 604, and the communication IF 605 are connected to one another by a bus. The processor 601 controls the management apparatus 202. The memory device 602 serves as a work area of the processor 601. Furthermore, the memory device 602 is a non-transitory or transitory recording medium that stores various programs and data. Examples of the memory device 602 include a ROM (Read Only Memory), a RAM (Random Access Memory), an HDD (Hard Disc Drive), and a flash memory. Data is input to the input device 603. Examples of the input device 603 include a keyboard, a mouse, a touch panel, a numeric keypad, and a scanner. The output device 604 outputs data. Examples of the output device 604 include a display and a printer. The communication IF 605 connects to the network 210 and transmits and receives data.

### Example of Functional Configuration of Management Apparatus 202

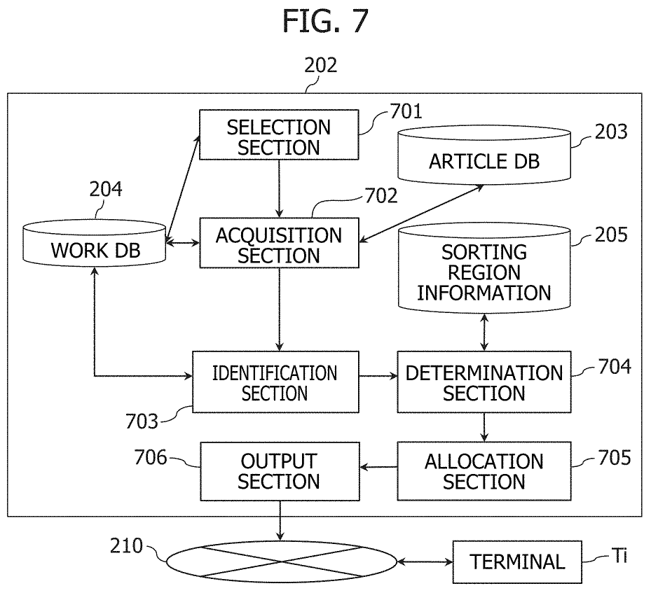

FIG. 7 is a block diagram depicting an example of a functional configuration of the management apparatus 202. The management apparatus 202 has a selection section 701, an acquisition section 702, an identification section 703, a determination section 704, an allocation section 705, and an output section 706. The selection section 701 to the output section 706 are functions realized by, for example, causing the processor 601 to execute the programs stored in the memory device 602 depicted in FIG. 6.

The selection section 701 selects one sorting destination identified by the sorting destination ID 501 from the work DB 204. The selection section 701 may select the sorting destination in order of the sorting destination IDs 501 or select the sorting destination at random. Alternatively, the selection section 701 may select the sorting destination in descending order or in ascending order of the number of articles to be sorted.

The acquisition section 702 acquires the size information about the articles to be sorted to the sorting destination selected by the selection section 701. Specifically, for example, the acquisition section 702 identifies the entry that matches the article ID of each of the articles to be sorted from the article DB 203 and acquires the size information 302 about the article in the identified entry. For example, in a case in which the article ID 301 of the article to be sorted is “A,” the acquisition section 702 acquires “GZa” as the size information 302.

The identification section 703 identifies size information about the sorting destination on the basis of the size information about the articles to be sorted acquired by the acquisition section 702 and the article counts of the articles to be sorted in the work data. Specifically, for example, the identification section 703 acquires the article count 503 of each of the articles to be sorted from the work DB 204 for each sorting destination, and multiplies the article count 503 by the size information 302 about each of the articles to be sorted acquired by the acquisition section 702. In a case in which the number of articles to be sorted is one, this multiplication result becomes the size information about the sorting destination. In a case in which the number of articles to be sorted is two or more, the identification section 703 multiplies the article count 503 of each of the articles to be sorted by the size information 302 for each article to be sorted. A sum of these multiplication results becomes the size information about the sorting destination.

For example, as for the work data having the sorting destination ID 501 of “Sd1” in the work DB 204, the article counts 503 of the articles to be sorted A, F, G, H, J, and L are NA1, NF1, NG1, NH1, NJ1, and NL1, respectively. Furthermore, the size information 302 about the articles to be sorted A, F, G, H, J, and L are GZa, GZf, GZg, GZh, GZj, and GZl, respectively. Therefore, the size information about the sorting destination Sd1 is (NA1×GZa)+(NF1×GZf)+(NG1×GZg)+(NH1×GZh)+(NJ1×GZj)+(NL1×GZl).

Alternatively, the identification section 703 may use the size information about the sorting destination multiplied by the safety factor higher than 0 and equal to or lower than 1 as the size information about the sorting destination. In another alternative, the identification section 703 may use a volumetric capacity of the sorting box storing the articles included in the sorting destination as the size information about the sorting destination. In yet another alternative, the identification section 703 may use the number of sorting boxes storing the articles included in the sorting destination as the size information about the sorting destination in a case in which the size information about the sorting destination is the number of sorting destinations that can be allocated to the sorting region.

In a case in which the sorting destination is a belonging sorting destination to a sorting team that is a set of one or more sorting destinations, the determination section 704 determines the number or a size of compartments of the sorting region for sorting the articles to be sorted to the sorting region on the basis of the size information about the sorting destination identified by the identification section 703 and the size information about the sorting region. Specifically, for example, the determination section 704 acquires size information about the sorting shelves SSi that are a sorting region from the sorting region information 205. In addition, the determination section 704 adds up the size information about the one or more sorting destinations. In a case in which an addition result exceeds the size information about the sorting regions, the determination section 704 determines the sorting destinations added before the addition result exceeds the size information as the belonging sorting destinations to the sorting team, and determines the size information about the sorting destinations added before the addition result exceeds the size information as the number or the size of compartments of the sorting regions for sorting the articles to be sorted to the sorting regions. Specifically, for example, if the size of the compartments is fixed, the determination section 704 determines the number of compartments for sorting the articles to be sorted to the sorting regions by dividing the size information about the sorting destinations added before the addition result exceeds the size information by a size of one compartment. If the size of the compartments is variable, the determination section 704 determines the size information about the sorting destinations added before the addition result exceeds the size information as the size of the compartments. It is noted that the sorting team is a combination of the belonging sorting destinations.

The allocation section 705 allocates a determination result by the determination section 704 to the sorting region. Specifically, for example, the allocation section 705 identifies a free sorting shelf SSi that is the sorting region in the work stations WSi, and allocates the sorting team that is the determination result to the sorting shelf SSi. Specifically, for example, one sorting team is allocated to one sorting shelf SSi. It is noted, for example, that the worker W of the work station WSi operates the terminal Ti and the allocation section 705 thereby receives information to the effect that the sorting shelf SSi in the work station WSi is free, so that the allocation section 705 can identify the sorting shelf SSi in a free state.

The output section 706 outputs an allocation result by the allocation section 705. Specifically, for example, the output section 706 transmits the sorting team that is the allocation result to the terminal Ti of the work station WSi where the sorting shelf SSi that is the sorting region, to which an allocation destination is sorted, is present. The terminal Ti receiving the sorting team displays the received sorting team on a display thereof. The worker W can thereby confirm the sorting team and perform the sorting work.

### Example of Management Process Procedures

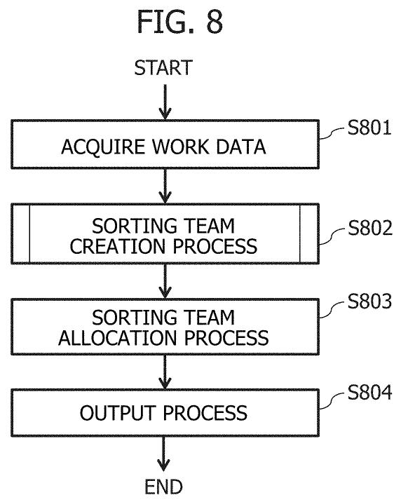

FIG. 8 is a flowchart depicting an example of management process procedures by the management apparatus 202 according to the first embodiment. The management apparatus 202 acquires a work data group from the work DB 204 (Step S801). Next, the management apparatus 202 executes a sorting team creation process by the acquisition section 702, the identification section 703, and the determination section 704 (Step S802), and executes a sorting team allocation process by the allocation section 705 (Step S803). The management apparatus 202 then executes an output process by the output section 706 (Step S804). The management apparatus 202 thereby ends a management process.

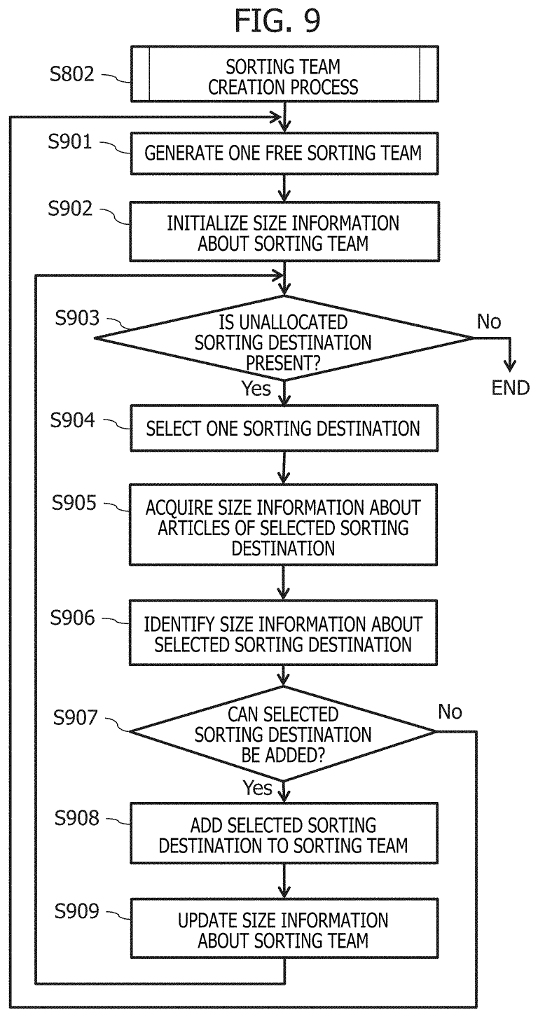

FIG. 9 is a flowchart depicting an example of detailed process procedures of the sorting team creation process (Step S802) depicted in FIG. 8. The management apparatus 202 generates one free sorting team (Step S901). The management apparatus 202 initializes size information about the generated sorting team (Step S902). The management apparatus 202 determines whether an unallocated sorting destination is present (Step S903). The unallocated sorting destination is work data that is not added to the sorting team in the work data group acquired in Step S801. In a case in which an unallocated sorting destination is not present (Step S903: No), the management apparatus 202 ends the sorting team creation process (Step S802). On the other hand, in a case in which an unallocated sorting destination is present (Step S903: Yes), the management apparatus 202 selects one unallocated sorting destination by the selection section 701 (Step S904). In other words, the management apparatus 202 selects one unallocated work data.

The management apparatus 202 acquires the size information about articles of the selected sorting destination from the article DB 203 (Step S905) by the acquisition section 702. The management apparatus 202 identifies the size information about the selected sorting destination by the identification section 703 (Step S906).

In a case in which the selected sorting destination ID 501 is, for example, “Sd1,” the management apparatus 202 identifies (NA1×GZa)+(NF1×GZf)+(NG1×GZg)+(NH1×GZh)+(NJ1×GZj)+(NL1×GZl) as the size information about the sorting destination Sd1 by the identification section 703.

Furthermore, the management apparatus 202 determines whether the selected sorting destination can be added to the sorting team by the determination section 704 (Step S907). Specifically, for example, the management apparatus 202 obtains a sum of the size information about the selected sorting destination identified in Step S906 and the size information about the sorting team. It is noted that in a case in which none of the selected sorting destinations is added to the sorting team, the size information about the sorting team is a value at a time of initialization (that is, zero).

The management apparatus 202 reads the size information about the sorting region from the sorting region information 205 and compares the size information with the sum. In a case in which the sum is equal to or smaller than the size information about the sorting region, the management apparatus 202 determines that the selected sorting destination can be added to the sorting team (Step S907: Yes). Furthermore, the management apparatus 202 determines the selected sorting destination as a belonging sorting destination to the sorting team and adds the selected sorting destination to the sorting team (Step S908). Moreover, the management apparatus 202 updates the size information about the sorting team by adding the size information about the selected sorting destination identified in Step S906 to the size information about the sorting team (Step S909). The management apparatus 202 returns to Step S903.

On the other hand, in a case in which the sum is larger than the size information about the sorting region, the management apparatus 202 determines that the selected sorting destination cannot be added to the sorting team (Step S907: No). In this case, the sorting team is defined without adding the selected sorting destination to the sorting team, and the management apparatus 202 returns to Step S901.

In this way, the management apparatus 202 uses the size information about the sorting destinations at the time of creating the sorting team. It is thereby possible to add more sorting destinations to the sorting region, compared with a case in which the number of compartments 103 of each sorting region is fixed as in, for example, Patent Document 1. Therefore, it is possible to exhibit an effect of improving warehouse work efficiency.

### Second Embodiment

A management system according to a second embodiment is an example of storing a plurality of sorting boxes having different sizes in the sorting shelf SSi.

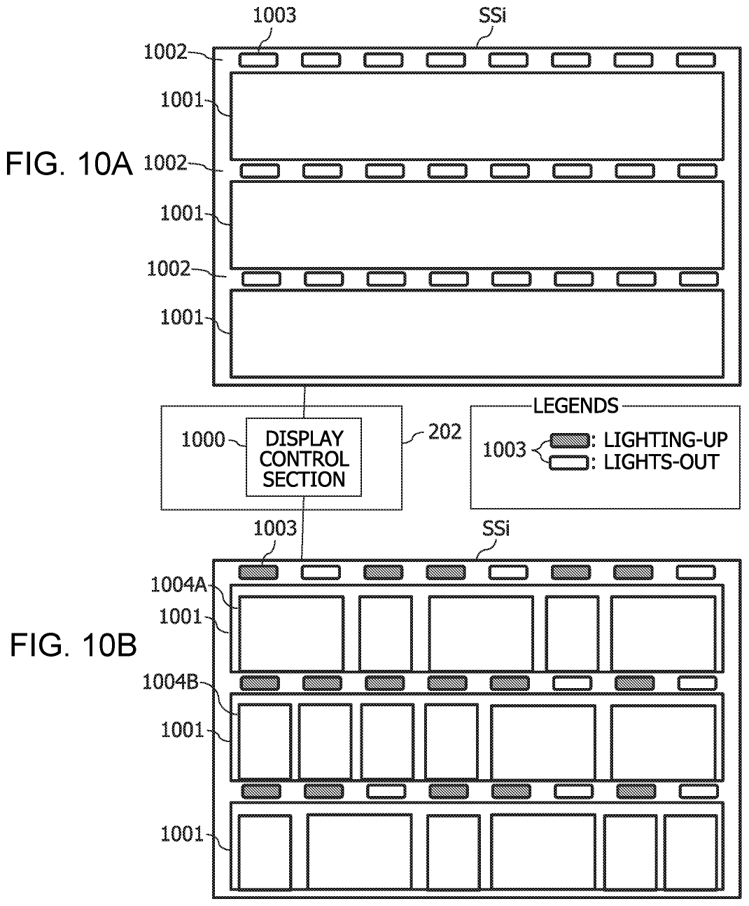

FIG. 10 is an explanatory diagram depicting examples of the sorting shelf SSi according to the second embodiment. FIG. 10(A) depicts a state in which none of the sorting boxes is stored, and FIG. 10(B) depicts a state in which sorting boxes are stored. In FIG. 10(A), the sorting shelf SSi has a plurality of stages (for example, three stages in FIG. 10) of storage regions 1001. Sorting boxes 1004 are stored in the storage regions 1001. One sorting box 1004 corresponds to, for example, one sorting destination.

A plurality of display sections 1003 are provided on a shelf board section 1002 on an upper edge side of each storage region 1001. Each display section 1003 displays information about an instruction to store the sorting box 1004. The display section 1003 is configured with, for example, a lamp, and is lit up or turned off by depressing the lamp itself. In a case of lighting-up, the display section 1003 is in a state of displaying the information about an instruction to store the sorting box 1004. The display section 1003 may be connected to the terminal Ti and may be lit up or turned off by inputting an operation to the display section 1003 from the terminal Ti. Furthermore, the display section 1003 may have a digital screen. In a case of the digital screen, the display section 1003 may be a touch panel. In this case, the display section 1003 is lit up or turned off by detecting that the touch panel is touched.

The sorting boxes 1004 include sorting boxes 1004A and 1004B at a plurality of types (for example, two types in FIG. 10) of sizes. The sorting boxes 1004A and 1004B have the same height. A width of the sorting box 1004B is twice as large as that of the sorting box 1004A. Therefore, a volumetric capacity of the sorting box 1004B is also twice as large as that of the sorting box 1004A. In other words, a size of the sorting box 1004A is a fundamental unit. For example, in a case in which the number of types of sizes of the sorting boxes 1004 is three or more, the sorting boxes 1004 other than the sorting box 1004A have widths and volumetric capacities that are integer multiples of those of the sorting box 1004A.

It is noted that the display section 1003 has a width corresponding to the width of the sorting box 1004A. Each sorting box 1004 is stored immediately under the display section 1003. Since each sorting box 1004B is twice as large as the sorting box 1004A that is the fundamental unit, the sorting box 1004B is stored immediately under the two display sections 1003 arranged side by side. Likewise, the sorting box 1004 three or more times as large as the sorting box 1004A is stored immediately under the three or more display sections 1003 arranged side by side. In this case, any one of the plurality of display sections 1003 arranged side by side may be lit up or turned off. In the example of FIG. 10(B), the left display section 1003 out of the two display sections 1003 arranged side by side is lit up or turned off, while the right display section 1003 is kept to be turned off.

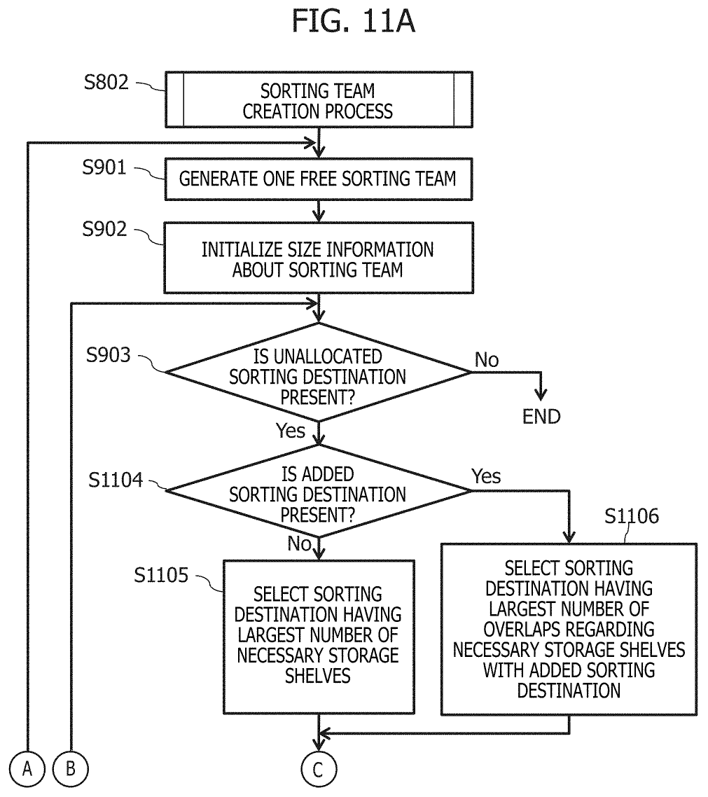

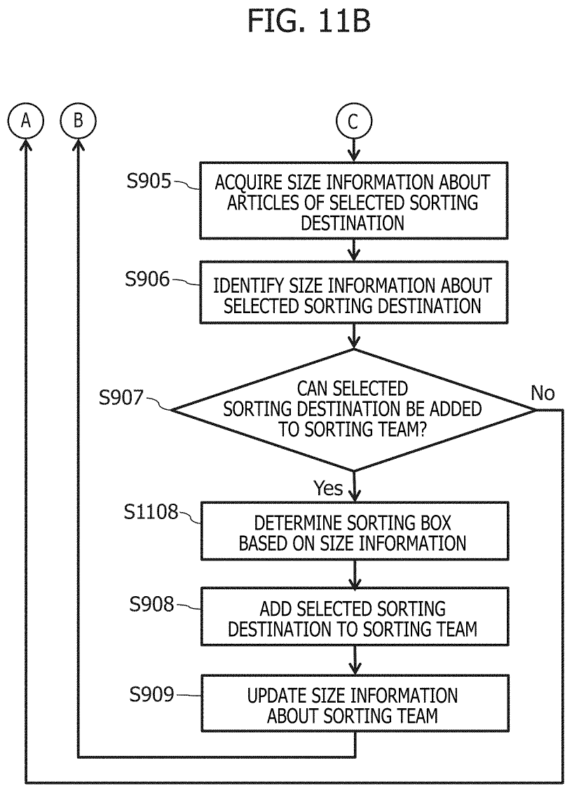

It is noted that the output section 706 outputs the allocation result to a display control section 1000 in FIG. 7. The display control section 1000 depicted in FIG. 10 is provided in the management apparatus 202. The display control section 1000 is communicably connected to the display sections 1003 via the network 210 and controls the display sections 1003 on the basis of the allocation result from the output section 706. Specifically, for example, the allocation result contains not only the sorting team to which the sorting destinations belong but also the sizes of the sorting boxes 1004 allocated to the sorting destinations in FIGS. 11A and 11B to be described later. It is assumed herein that the size of the sorting box 1004A is “large” and the size of the sorting box 1004B is “small.”

The display control section 1000 allocates the sizes of the sorting boxes 1004 from a left end of the storage region 1001 in the uppermost stage in descending order of the sorting destination ID 501. For example, as depicted in FIG. 10(B), the sorting box 1004A at the size “large” is allocated to the sorting destination Sd1, the sorting box 1004B at the size “small” is allocated to the sorting destination Sd2, the sorting box 1004A at the size “large” is allocated to the sorting destination Sd3, the sorting box 1004B at the size “small” is allocated to the sorting destination Sd4, the sorting box 1004A at the size “large” is allocated to the sorting destination Sd5, the sorting box 1004B at the size “small” is allocated to the sorting destination Sd6, the sorting box 1004B at the size “small” is allocated to the sorting destination Sd7, the sorting box 1004B at the size “small” is allocated to the sorting destination Sd8, the sorting box 1004B at the size “small” is allocated to the sorting destination Sd9, the sorting box 1004A at the size “large” is allocated to the sorting destination Sd10, the sorting box 1004A at the size “large” is allocated to the sorting destination Sd11, the sorting box 1004B at the size “small” is allocated to the sorting destination Sd12, the sorting box 1004A at the size “large” is allocated to the sorting destination Sd13, the sorting box 1004B at the size “small” is allocated to the sorting destination Sd14, the sorting box 1004A at the size “large” is allocated to the sorting destination Sd15, the sorting box 1004B at the size “small” is allocated to the sorting destination Sd16, and the sorting box 1004B at the size “small” is allocated to the sorting destination Sd17.

The display control section 1000 highlights (for example, lights up) the left display section 1003 and unhighlights (for example, turns off) the right display section 1003 out of the two display sections 1003 arranged side by side and corresponding to a storage position of storing each of the sorting boxes 1004 of the sorting destinations to which the size “large” is allocated. Highlighting is information about an instruction to store the sorting box 1004. Furthermore, the display control section 1000 highlights (for example, lights up) the display section 1003 corresponding to the storage position of storing each of the sorting boxes 1004 of the sorting destinations to which the size “small” is allocated. The storage positions of the sorting boxes 1004 at the necessary sizes are thereby secured in the sorting shelf SSi. The worker W checks a display state of the display section 1003, stores the sorting box 1004 at the corresponding size in the sorting shelf SSi, and stores the articles picked from the storage shelf CS in the sorting box 1004 corresponding to the sorting destination.

Furthermore, in FIG. 7, the selection section 701 executes a selection process different from that according to the first embodiment. This respect will be described later with reference to FIGS. 11A and 11B.

### Example of Sorting Team Creation Process Procedures

FIGS. 11A and 11B illustrate a flowchart depicting an example of detailed process procedures of the sorting team creation process (Step S802) depicted in FIG. 8 according to the second embodiment. The same processes as those in FIG. 9 are denoted by the same step numbers and description thereof will be omitted.

In a case in which an unallocated sorting destination is present (Step S903: YES), the management apparatus 202 determines whether a sorting destination added to the sorting team is present (Step S1104). In other words, the management apparatus 202 determines whether the sorting team is an empty set.

In a case in which an added sorting destination is not present (Step S1104: Yes), that is, in a case in which the sorting team is an empty set, the management apparatus 202 selects the sorting destination having the largest number of necessary storage shelves (Step S1105) by the selection section 701 and goes to Step S905. Specifically, for example, referring to FIG. 5 indicates that the articles to be sorted to the sorting destination Sd1 are the articles A, F, G, H, J, and L; thus, referring to FIG. 4 indicates that the storage shelves CS housing these articles to be sorted are the storage shelves CS1, CS2, and CS3. Therefore, the number of necessary storage shelves of the sorting destination Sd1 is “three.”

Likewise, the number of necessary storage shelves of the sorting destination Sd2 is “two” (CS2 and CS4), the number of necessary storage shelves of the sorting destination Sd3 is “two” (CS1 and CS3), and the number of necessary storage shelves of the sorting destination Sd4 is “two” (CS1 and CS4). Therefore, the management apparatus 202 selects the sorting destination Sd1, the largest number of necessary storage shelves of which is “three,” by the determination section 704. While selecting the sorting destination having the largest number of necessary storage shelves in Step S1105, the management apparatus 202 may select the sorting destination having the number of storage shelves equal to or higher than a threshold. It is noted that in a case in which a plurality of selection candidates as the sorting destinations are present, the management apparatus 202 may select one sorting destination at random from among the selection candidates by the selection section 701.

Furthermore, in the case in which an added sorting destination is present in Step S1104 (Step S1104: Yes), that is, in the case in which the sorting destination is not an empty set, the management apparatus 202 selects the sorting destination having the largest number of overlaps regarding necessary storage shelves CS with the added sorting destination (Step S1106) by the selection section 701 and goes to Step S905.

In the example described above, it is assumed that the sorting destination Sd1 is the added sorting destination. The storage shelves CS storing the articles to be sorted to the sorting destination Sd1 are the storage shelves CS1, CS2, and CS3. The number of overlaps of the sorting destination Sd1 with the sorting destination Sd2 is “one” (CS2), the number of overlaps thereof with the sorting destination Sd3 is “two” (CS1 and CS3), and the number of overlaps thereof with the sorting destination Sd4 is “one” (CS4). Therefore, the management apparatus 202 selects the sorting destination Sd3 having the largest number of overlaps with the sorting destination Sd1 by the selection section 701. Furthermore, the management apparatus 202 may select the sorting destination having the number of overlaps equal to or higher than a threshold in Step S1106 similarly to Step S1105. It is noted that in a case in which a plurality of selection candidates as the sorting destinations are present, the management apparatus 202 may select one sorting destination at random from among the selection candidates by the selection section 701.

Subsequently, the management apparatus 202 acquires the size information about the articles of the selected sorting destination in Step S1105 or S1106 (Step S905).

Furthermore, in a case of determining that the selected sorting destination can be added to the sorting team by the selection section 704 (Step S907: Yes), that is, in a case of determining that the selected sorting destination is a belonging sorting destination, the management apparatus 202 determines the sorting box 1004 allocated to the belonging sorting destination from among the sorting boxes 1004 at the plurality of different sizes on the basis of the size information about the belonging sorting destination by the determination section 704.

Specifically, for example, the size information such as a maximum volumetric capacity is determined for each sorting box 1004. Furthermore, the size information about the selected sorting destination is a sum of a volume of each of the articles to be sorted which are sorted to the selected sorting destination by the article count. Therefore, the management apparatus 202 compares the size information about the selected sorting destination with the size information about the sorting box 1004 and determines the sorting box 1004 at the size at which all of the articles to be sorted of the selected sorting destination can be stored by the determination section 704.

For example, it is assumed that the maximum volumetric capacity of the sorting box 1004A depicted in FIG. 10 is 2V, the maximum volumetric capacity of the sorting box 1004B is V, and the sum of the volumes of the articles to be sorted that is the size information about the selected sorting destination is Σ. It is noted that the maximum volumetric capacity V or 2V may be multiplied by the safety factor higher than 0 and equal to or lower than 1. In a case of Σ≤V, the determination section 704 determines the sorting box 1004B as the sorting box 1004 allocated to the selected sorting destination. In a case of V<Σ≤2 V, the determination section 704 determines the sorting box 1004A as the sorting box 1004 allocated to the selected sorting destination. It is noted that the sorting box 1004 at the maximum size, that is, the sorting box 1004 at the maximum size which is an integer multiple of the volumetric capacity (or width) of the sorting box 1004B that is the fundamental unit is prepared so that the size information about the selected sorting destination does not exceed the volumetric capacity of the sorting box 1004 at the maximum size. The management apparatus 202 then adds the selected sorting destination to the sorting team (Step S908).

Subsequently, in the sorting team allocation process (Step S803), the management apparatus 202 generates an allocation result containing the size of the sorting box 1004 for each sorting destination in each sorting team by the allocation section 705, and sends the allocation result to the display control section 1000 by the output section 706. In addition, the display control section 1000 controls the display section 1003 as described above.

In a case in which the size or the number of the compartments 103 of the sorting region is fixed, it is necessary to determine the size or the number of the compartments 103 while supposing a case in which the size of the sorting destination is the maximum. Changing the size of the sorting box 1004 depending on the size information about the sorting destination as described in the second embodiment makes it possible to increase the number of sorting destinations in the sorting team. This can increase the number of sorting destinations that can be sorted by one sorting work performed by the worker. Therefore, the number of times of worker's moving to the storage shelves CS can be reduced, which exhibits an effect of improving work efficiency.

It is noted that a scheme of selecting the sorting box 1004 is not limited to the above scheme but any of various suitable methods can be executed. For example, adjustment may be made such that two sorting boxes 1004 at the small size are disposed consecutively, and a partition may be provided in the sorting box 1004 at the large size so that the sorting box 1004 at the large size is used as the two sorting boxes 1004 at the small size.

Providing the display sections 1003 on each sorting shelf SSi enables the worker W to be instructed in how many sorting boxes 1004 at the different sizes are provided in the sorting shelf SSi. It is noted that a method of presenting the storage position of each sorting box 1004 is not limited to the method described above but any of various suitable methods can be selected. For example, each sorting region may be provided with an optical indicator such as a laser pointer or a projector and the indicator may be used to display information on the display section 1003. In this way, providing the sorting shelf SSi with the display sections 1003 each changing in a display mode depending on the size information about the sorting destination makes it possible to explicitly indicate the size information about the sorting destination and to prevent worker W's work errors.

### Third Embodiment

A third embodiment is an example of carrying the storage shelf CS to the work station WSi using an autonomously moving carrier vehicle and returning the storage shelf CS to an original position after end of picking in the first and second embodiments.

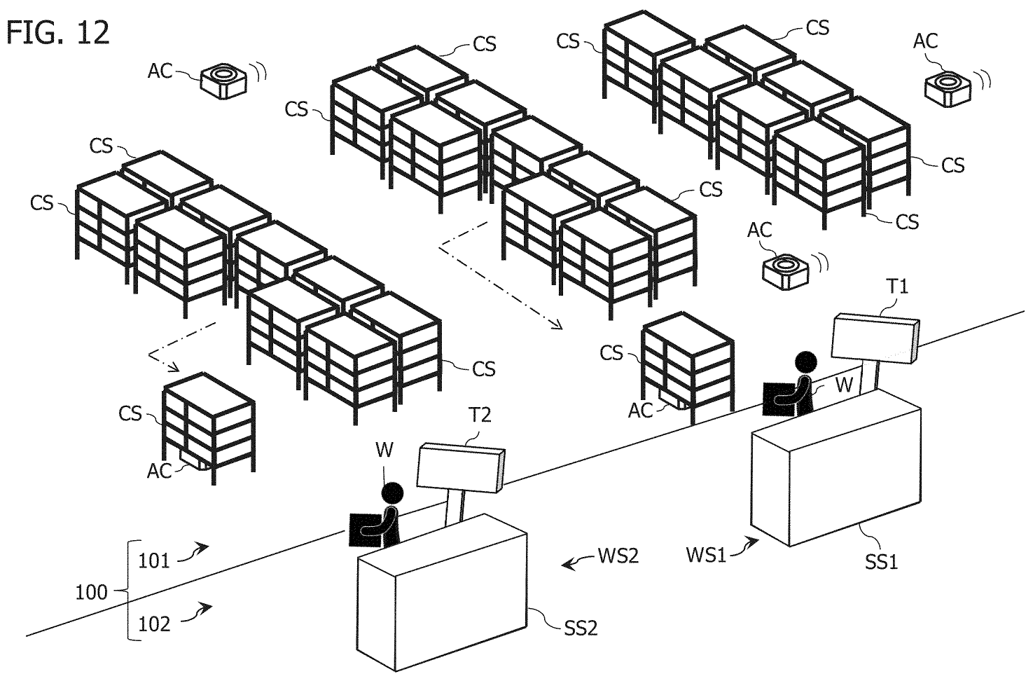

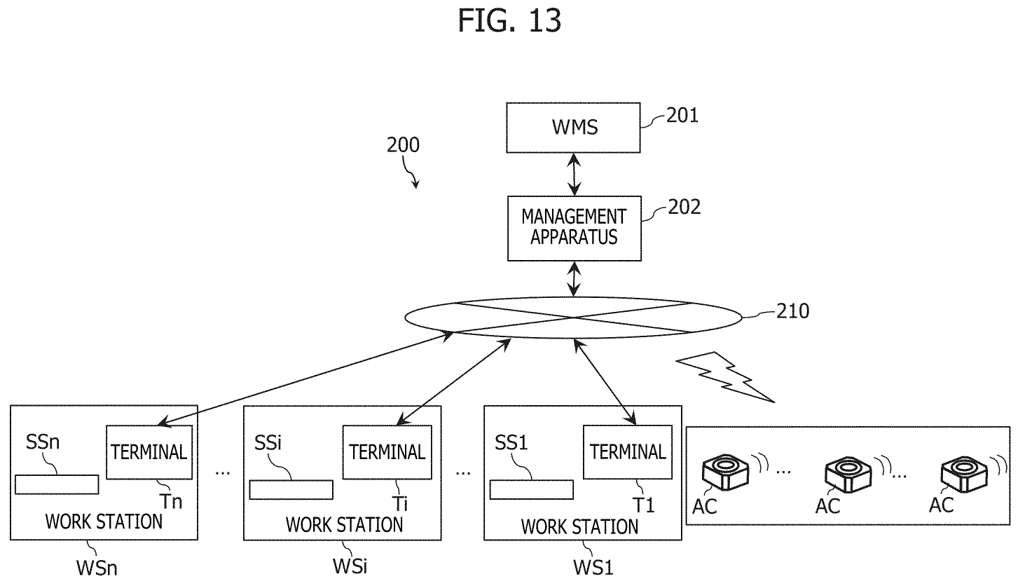

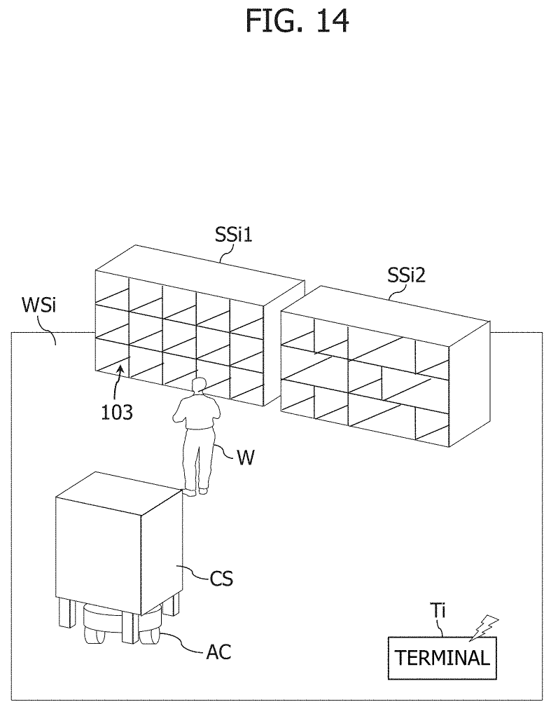

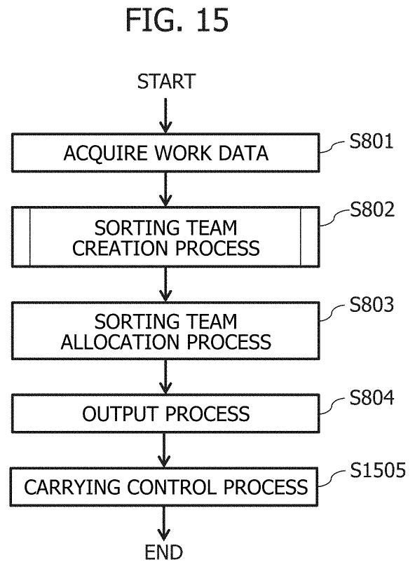

FIG. 12 is an explanatory diagram depicting an example of a warehouse using a carrier vehicle according to the third embodiment. FIG. 13 is an explanatory diagram depicting an example of a system configuration of a management system according to the third embodiment. FIG. 14 is an explanatory diagram depicting an example of sorting work in the work station WSi according to the third embodiment. FIG. 15 is a flowchart depicting an example of management process procedures by the management apparatus 202 according to the third embodiment.

A carrier vehicle AC moves in the storage shelf area 101. The carrier vehicle AC is connected to the management apparatus 202 via the network 210 in such a manner as to be communicable with the management apparatus 202 by wireless connection. The management apparatus 202 executes a carrying control process (Step S1505) in the third embodiment after outputting the allocation result by the output process (Step S804).

In the carrying control process (Step S1505), the management apparatus 202 transmits a carrying instruction to the carrier vehicle AC. The carrier vehicle AC receives the carrying instruction from the management apparatus 202. The carrying instruction contains the article data (entries selected from the article DB 203), position information about the storage shelf CS identified by the shelf ID contained in the article data, and an ID and position information about the work station WSi that is a carrying destination. The carrier vehicle AC moves immediately under the storage shelf CS and is stopped while referring to the received article data, and lifts the storage shelf CS by a lifting mechanism that is not depicted. The storage shelf CS is moved to the work station WSi that is the carrying destination in a state of being lifted.

Upon arrival of the storage shelf CS at the work station WSi by the carrier vehicle AC, the worker W picks the articles to be sorted from the storage shelf CS, and sorts the articles to be sorted to the sorting shelves SSi in accordance with the allocation result displayed on the terminal Ti and highlighting of the display sections 1003 depicted in FIG. 10. When the worker W operates the terminal Ti to transmit a work completion notification to the management apparatus 202, the management apparatus 202 transmits an instruction to the carrier vehicle AC having carried the storage shelf CS to return the storage shelf CS. Upon receiving the return instruction, the carrier vehicle AC carries the storage shelf CS back to an original position.

While the example of using the carrier vehicle AC has been described above, the carrier vehicle AC may be attached to the storage shelf CS. Furthermore, while the carrier vehicle AC has been described as an example of the carrier mechanism, the carrier mechanism may be a belt conveyor.

Moreover, while the example of carrying the storage shelf CS to the work station WSi has been described above, the sorting shelf SSi may be carried in front of the storage shelf CS and the worker W. Furthermore, both the storage shelf CS and the sorting shelf SSi may be carried in front of the worker W. This makes it unnecessary for the worker W to move between the storage shelf CS and the sorting shelf and makes it possible to improve the work efficiency.

Furthermore, in a case of applying the third embodiment to the second embodiment, changing the size of the sorting box 1004 depending on the size information about the sorting destination makes it possible to increase the number of sorting destinations in the sorting team. This can increase the number of sorting destinations that can be sorted by causing the carrier vehicle AC to carry the storage shelf CS once. Therefore, it is possible to reduce the number of times of carrying the storage shelf CS by the carrier vehicle AC and to exhibit the effect of improving the work efficiency.

In this way, the management system 200 described above includes: the management apparatus 202; and the sorting shelf SSi that is an example of a sorting region where articles are sorted to a plurality of sorting destinations. The management apparatus 200 stores article data (article DB 203) that causes each of the articles to correspond to size information about the article, work data (work DB 204) that causes one or more articles to be sorted that are sorted to the sorting destinations among the articles to correspond to the article count of the one article or each of the articles to be sorted, and the sorting region information 205 in the memory device 602.

The processor 601 executes: an acquisition process of acquiring size information about the articles to be sorted from the article data (article DB 203) by the acquisition section 702, an identification process of identifying size information about each of the sorting destinations on the basis of the size information about the articles to be sorted acquired by the acquisition process and the article count of the one article or each of the articles to be sorted in the work data (work DB 204) by the identification section 703, a determination process of determining the number or a size of compartments of the sorting region for sorting the articles to be sorted to the sorting region on the basis of the size information about each of the sorting destinations identified by the identification process and the sorting region information 205 by the determination section 704 in a case in which each of the sorting destinations is a belonging sorting destination to a sorting team that is a set of one or more sorting destinations, and an allocation process of allocating a determination result by the determination process to the sorting region by the allocation section 705.

It is thereby possible to achieve improvement in work efficiency of the sorting work such that it is possible to automatically generate the sorting team upon determining the number or the size of the compartments of the sorting region for the sorting destinations, and to efficiently sort the articles of the sorting destinations to the sorting region.

Furthermore, the management system 200 has a storage region (storage shelf CS) where the articles are housed, and the processor 601 executes a selection process of selecting a specific sorting destination from among the plurality of sorting destinations on the basis of the number of storage regions (storage shelf CS) that are housing destinations of the articles to be sorted by the selection section 701; in the acquisition process, the processor 601 acquires size information about the articles to be sorted that are sorted to the specific sorting destination selected by the selection process, from the article data (article DB 203) by the acquisition section 702; in the identification process, the processor 601 identifies size information about the specific sorting destination by the identification section 703; and in the determination process, the processor 601 determines the number or the size of the compartments of the sorting region for sorting the articles to be sorted to the sorting region (sorting shelf SSi) on the basis of the size information about the specific sorting destination and the sorting region information 205 in a case in which the specific sorting destination is a belonging sorting destination to the sorting team that is the set of the one or more sorting destinations, by the determination section 704.

It is thereby possible to select, for example, the sorting destination having the larger number (for example, the largest number) of necessary storage shelves CS as the sorting destination for which the size information about the articles is acquired. Overlaps of the selected sorting destination with the other sorting destination in the sorting team regarding the storage shelves CS where the articles to be sorted are housed thereby tend to easily occur; thus, it is possible to achieve improvement in carrying efficiency of the storage shelves CS.

Moreover, in the selection process, the processor 601 selects the specific sorting destination on the basis of the number (for example, the largest number) of overlaps between the storage region (storage shelf CS) that is the housing destination of the articles to be sorted that are sorted to the belonging sorting destination and the storage region (sorting shelf CS) that is a housing destination of the articles to be sorted that are sorted to a sorting destination not belonging to the sorting team. Thus, in a case of overlaps of the sorting destination with the other sorting destination regarding the storage shelves CS where the articles to be sorted are housed, the sorting destinations are incorporated into the same sorting team. Therefore, the number of times of carrying the sorting shelf CS to the work station WSi is reduced and the number of times of worker W's moving to the sorting shelf CS is reduced. It is, therefore, possible to achieve improvement in sorting work efficiency.

Furthermore, the sorting region (sorting shelf SSi) can store a plurality of sorting boxes 1004 at different sizes, and in the determination process, the processor 601 determines the sorting box 1004A or 1004B allocated to the belonging sorting destination from among the plurality of sorting boxes 1004 at the different sizes on the basis of size information about the belonging sorting destination. The sorting box 1004 at the size depending on the size (volume) of the articles to be sorted that are sorted to the sorting destination is thereby allocated to the sorting destination; thus, a free region in the sorting region (sorting shelf SSi) is reduced. In other words, it is possible to allocate more sorting destinations to the sorting region (sorting shelf SSi); thus, it is possible to achieve improvement in the sorting work efficiency.

Moreover, the sorting region (sorting shelf SSi) has the display section 1003 that is provided to correspond to a storage position of each of the sorting boxes 1004 and that displays information as to whether to store the sorting box 1004 (an instruction to dispose the sorting box 1004 in a case of highlighting the display section 1003, or an instruction not to dispose the sorting box 1004 in a case of unhighlighting the display section 1003). In addition, the processor 601 controls the display section 1003 by the display control section 1000 in such a manner as to display the information as to whether to store the sorting box 1004 on the basis of an allocation result by the allocation process. It is thereby possible to instruct the worker W as to at what storage position of the sorting region (sorting shelf SSi), the sorting box 1004 at what size is stored.

Furthermore, the management apparatus 202 is communicably connected to the movable carrier mechanism (for example, carrier vehicle AC), and the processor 601 controls the carrier mechanism in such a manner as to carry the sorting region (sorting shelf SSi) to a designated position. It is thereby unnecessary for the worker W to carry the sorting region (sorting shelf SSi) in a case in which the worker W is at the designated position; thus, it is possible to achieve improvement in the sorting work efficiency.

Moreover, the management system 200 has the storage region (storage shelf CS) where the articles are housed, and the processor 601 may control the carrier mechanism (for example, carrier vehicle AC) in such a manner as to carry at least one of the storage region (storage shelf CS) and the sorting region (sorting shelf SSi) to the designated position. It is thereby unnecessary for the worker W to carry at least one of the storage region (storage shelf CS) and the sorting region (sorting shelf SSi) in the case in which the worker W is at the designated position; thus, it is possible to achieve improvement in the sorting work efficiency.

As described so far, it is possible to achieve improvement in the work efficiency of the sorting work according to the first to third embodiments.

The present invention is not limited to the embodiments described above but encompasses various modifications and equivalent configurations within the meaning of the accompanying claims. For example, the above-mentioned embodiments have been described in detail for describing the present invention so that the present invention is easy to understand, and the present invention is not always limited to the embodiments having all the described configurations. Furthermore, a part of the configurations of a certain embodiment may be replaced by configurations of another embodiment. Moreover, the configurations of another embodiment may be added to the configurations of the certain embodiment. Further, for part of the configurations of each embodiment, addition, deletion, or replacement may be made of the other configurations.

Moreover, a part of or all of the configurations, the functions, the processing sections, processing means, and the like described above may be realized by hardware by being designed, for example, as an integrated circuit, or may be realized by software by causing the processor to interpret and execute programs that realize the functions.

Information in programs, tables, files, and the like for realizing the functions can be stored in a memory device such as a memory, a hard disc, or an SSD (Solid State Drive), or in a recording medium such as an IC (Integrated Circuit) card, an SD card, or a DVD (Digital Versatile Disc).

Furthermore, control lines or information lines considered to be necessary for the description are illustrated and all the control lines or the information lines necessary for implementation are not always illustrated. In actuality, it may be contemplated that almost all the configurations are mutually connected.

1. A management system comprising:
a management apparatus having a processor that executes a program and a memory device that stores the program; and a sorting region where articles are sorted to a plurality of sorting destinations, wherein
the memory device stores article data that causes each of the articles to correspond to size information about the article, work data that causes one or more articles to be sorted that are sorted to the sorting destinations among the articles to correspond to an article count of the one article or each of the articles to be sorted, and size information about the sorting region, and
the processor executes:
an acquisition process of acquiring size information about the articles to be sorted from the article data,
an identification process of identifying size information about each of the sorting destinations on the basis of the size information about the articles to be sorted acquired by the acquisition process and the article count of the one article or each of the articles to be sorted in the work data,
a determination process of determining a number or a size of compartments of the sorting region for sorting the articles to be sorted to the sorting region on the basis of the size information about each of the sorting destinations identified by the identification process and the size information about the sorting region in a case in which each of the sorting destinations is a belonging sorting destination to a sorting team that is a set of one or more sorting destinations, and
an allocation process of allocating a determination result by the determination process to the sorting region.

2. The management system according to claim 1, including:
a storage region where the articles are housed, wherein
the processor executes a selection process of selecting a specific sorting destination from among the plurality of sorting destinations on the basis of a number of storage regions that are housing destinations of the articles to be sorted,
in the acquisition process, the processor acquires size information about the articles to be sorted that are sorted to the specific sorting destination selected by the selection process, from the article data,
in the identification process, the processor identifies size information about the specific sorting destination, and
in the determination process, the processor determines the number or the size of the compartments of the sorting region for sorting the articles to be sorted to the sorting region on the basis of the size information about the specific sorting destination and the size information about the sorting region in a case in which the specific sorting destination is a belonging sorting destination to the sorting team that is the set of the one or more sorting destinations.

3. The management system according to claim 2, wherein
in the selection process, the processor selects a sorting destination having a largest number of the storage regions where the articles to be sorted are housed, as the specific sorting destination.

4. The management system according to claim 2, wherein
in the selection process, the processor selects the specific sorting destination on the basis of a number of overlaps between a storage region that is a housing destination of the articles to be sorted that are sorted to the belonging sorting destination and a storage region that is a housing destination of the articles to be sorted that are sorted to a sorting destination not belonging to the sorting team.

5. The management system according to claim 4, wherein
in the selection process, the processor selects a sorting destination having the largest number of the overlaps as the specific sorting destination.

6. The management system according to claim 1, wherein
the sorting region can store a plurality of sorting boxes at different sizes, and
in the determination process, the processor determines sorting boxes allocated to the belonging sorting destination from among the plurality of sorting boxes at the different sizes on the basis of size information about the belonging sorting destination.

7. The management system according to claim 6, wherein
the sorting region has a display section that is provided to correspond to a storage position of each of the sorting boxes and that displays information about an instruction to store each of the sorting boxes, and
the processor executes a display process of controlling the display section to display the information about the instruction in such a manner as to store each of the sorting boxes on the basis of an allocation result by the allocation process.

8. The management system according to claim 1, wherein
the management apparatus is communicably connected to a movable carrier mechanism, and
the processor executes a control process of controlling the carrier mechanism in such a manner as to carry the sorting region to a designated position.

9. The management system according to claim 8, including
a storage region where the articles are housed, wherein
the processor executes the control process of controlling the carrier mechanism in such a manner as to carry at least one of the storage region and the sorting region to the designated position.

10. A management method by a management apparatus having a processor that executes a program and a memory device that stores the program, wherein
the memory device stores article data that causes each of the articles to correspond to size information about the article, work data that causes one or more articles to be sorted that are sorted to sorting destinations among the articles to correspond to an article count of the one article or each of the articles to be sorted, and size information about the sorting region where the articles are sorted to the sorting destinations, and
the management method comprises:
executing by the processor an acquisition process of acquiring size information about the articles to be sorted from the article data,
executing by the processor an identification process of identifying size information about each of the sorting destinations on the basis of the size information about the articles to be sorted acquired by the acquisition process and the article count of the one article or each of the articles to be sorted in the work data;
executing by the processor a determination process of determining a number or a size of compartments of the sorting region for sorting the articles to be sorted to the sorting region on the basis of the size information about each of the sorting destinations identified by the identification process and the size information about the sorting region in a case in which each of the sorting destinations is a belonging sorting destination to a sorting team that is a set of one or more sorting destinations; and
executing by the processor an allocation process of allocating a determination result by the determination process to the sorting region.

11. A management program executed by a processor accessible to a memory device, wherein
the memory device stores article data that causes each of the articles to correspond to size information about the article, work data that causes one or more articles to be sorted that are sorted to sorting destinations among the articles to correspond to an article count of the one article or each of the articles to be sorted, and size information about the sorting region where the articles are sorted to the sorting destinations, and
the management program causes the processor to execute:
an acquisition process of acquiring size information about the articles to be sorted from the article data;
an identification process of identifying size information about each of the sorting destinations on the basis of the size information about the articles to be sorted acquired by the acquisition process and the article count of the one article or each of the articles to be sorted in the work data;
a determination process of determining a number or a size of compartments of the sorting region for sorting the articles to be sorted to the sorting region on the basis of the size information about each of the sorting destinations identified by the identification process or the size information about the sorting region in a case in which each of the sorting destinations is a belonging sorting destination to a sorting team that is a set of one or more sorting destinations; and
an allocation process of allocating a determination result by the determination process to the sorting region.
